(19) United States
(12) Patent Application Publication
(10) Pub. No.: US 2007/0144834 A1
(43) Pub. Date: Jun. 28, 2007

(54) Controlling lubrication of moving bodies such as bearings of electric motors

(76) Inventor: Eugene Matzan, Rochester, NY (US)

Correspondence Address: Alexander E. Martens, 63 Winding Creek Lane, Rochester, NY, 14625, US

(21) Appl. No.: 11/603,728

(22) Filed: Nov. 24, 2006

Related U.S. Application Data
(60) Provisional application No. 60/754,155, filed on Dec. 28, 2005.

(51) Int. Cl. F16N 11/08

(52) U.S. Cl. 184/37

(57) ABSTRACT

A self-powered automatic lubrication system for electric motors utilizes an electromagnetic sensor/generator, which picks up motor vibrations that are synchronous with the rotations of the motor shaft, and in response, generates an alternating current. The current is rectified and used to charge a secondary battery that supplies power to the electronic control system. This control system utilizes the alternating current produced by the sensor/generator as an output signal to time the injection of the lubricant into the motor bearings. The sensor/generator comprises a coil and a permanent magnet suspended by springs within the coil. The magnet moves as the motor vibrates causing electric current to be generated in the coil. The physical parameters of the magnet and the springs are selected such that the movement occurs in resonance with the fundamental frequency of the motor vibrations.

The present invention relates to a system for controlling injection of lubricants into cyclically moving mechanisms and particularly into the bearings of such mechanisms electric motors, specifically, the bearings of electric motors.

### BACKGROUND OF THE INVENTION

High power electric motors require periodic lubrication of their bearings to ensure proper operation, long life and to prevent catastrophic failures. Such motors installed in difficult to access locations are equipped with devices, which automatically inject the lubricants into the bearings in defined time intervals. These motors usually operate intermittently rather than continuously as required for a particular application, This, however, is not an optimum procedure, wasteful of lubricant and may not prevent overheating and failure if the lubrication does not occur when the conditions would require it. In accordance with the invention, it has been observed that control of lubrication based on either on a number of shaft rotations or on the cumulative duration of the time intervals when the motor is working is more effective in providing lubrication sufficient to prevent bearing failures.

### SUMMARY OF THE INVENTION

The present invention relates to an automatic system for lubrication for cyclically operating mechanisms, such as rotary mechanisms, which controls the lubrication as a function of the number of rotations or as a function of the cumulative duration of the mechanism's operating intervals, rather than in predetermined time intervals. The system is especially adapted to control lubrication of the bearings of electric motors The system, in accordance with the present invention, is self-powered, and can provide for maintaining the charge of an internal battery.

In its operation, the automatic lubrication system takes advantage of the motor's vibration, the fundamental frequency of which is synchronous with the motor shaft rotation.

The system includes a dual function magnetic sensor/generator, which picks up the vibration and generates electric current. This current is used as an indicator of the fact that that the motor is operating and as a source for trickle charging a secondary battery that supplies power to the system.

The sensor/generator includes a toroidally shaped coil and a concentric toroidally shaped permanent magnet that is suspended by springs and restrained by a shaft in its center to vertical motion within the coil. The physical parameters of the magnet and the springs are selected for the structure to be in resonance with the fundamental harmonic of the motor's vibration. This arrangement increases the amplitude of the magnet's motion and, consequently, the sensitivity of the sensor while enhancing the generation of the current in the coil.

Two approaches are disclosed for controlling the timing of lubricant injection: as a function of a preset number of motor shaft turns implemented by means of a counter that is preset to a desired number; or by measuring the cumulative operating time of the motor until a preset value is reached. In either case, when the preset number is reached, the lubrication cycle is automatically initiated.

### BRIEF DESCRIPTION OF THE DRAWINGS

FIG. 1A shows in a block diagram form an electric motor equipped with a lubricant dispenser and a sensor/generator.

FIG. 1B depicts a lubricant dispenser.

FIGS. 2A and 2B are cross-sectional drawings diagrammatically illustrative of the sensor/generator in accordance with the invention. FIG. 2A shows a cross-section along the line BB in FIG. 2B and FIG. 2B shows a cross-section along the line AA in FIG. 2A.

FIG. 3. is a block diagram of one embodiment of the system for automatic motor lubrication control system in accordance with the invention.

FIG. 4 is a block diagram of another embodiment of the system for automatic motor lubrication control system in accordance with the invention.

### DESCRIPTION OF THE PREFERRED EMBODIMENTS

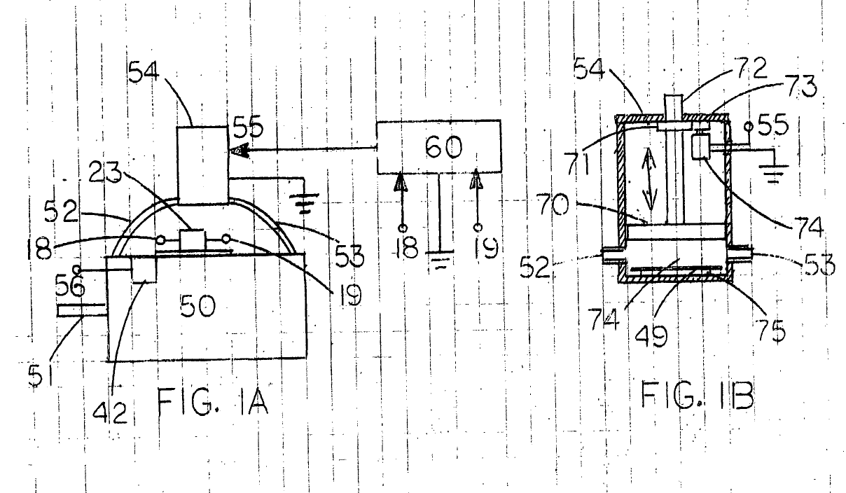

FIG. 1A depicts an electric motor 50 with a shaft 51, a lubricant dispenser 54 and a sensor/generator 23. The lubricant is injected into the bearings of the motor 50 via tubes 52 and 53. the lubricant dispenser 54 receives it power from the control module 50, which, in turn, receives electric current from the sensor/generator 23 via the terminals 18 and 19. A temperature sensor 42 is attached to the body of the motor 50.

FIG. 1B shows a cross-section of the cylindrically shaped lubricant dispenser 54 with a piston 70 driven in the direction indicated by the arrows by means of a lead screw 72. The position of the piston 72 determines the variable internal volume 76 of the lubricant dispenser 54 where the lubricant is contained. As the piston 70 moves toward the outlets 52 and 53, it squeezes out the lubricant, which is then injected into the bearings of the motor 50. the lead screw 72 is driven by the rotating gear/nut 71, which is constrained from moving in the vertical direction. The gear/nut 71 has an internal thread and teeth along its external cylindrical surface. The gear/nut 71 is driven by a smaller gear 73 attached to a small electric motor, which can be either DC or a stepper motor 74. The motor 74 received its electric power from the control module 60 via terminal 55.

The lubricant dispenser 54 also contains a capacitive proximity sensor the purpose of which is to monitor in real time the volume of the lubricant and to generate and alarm when the volume is too low.

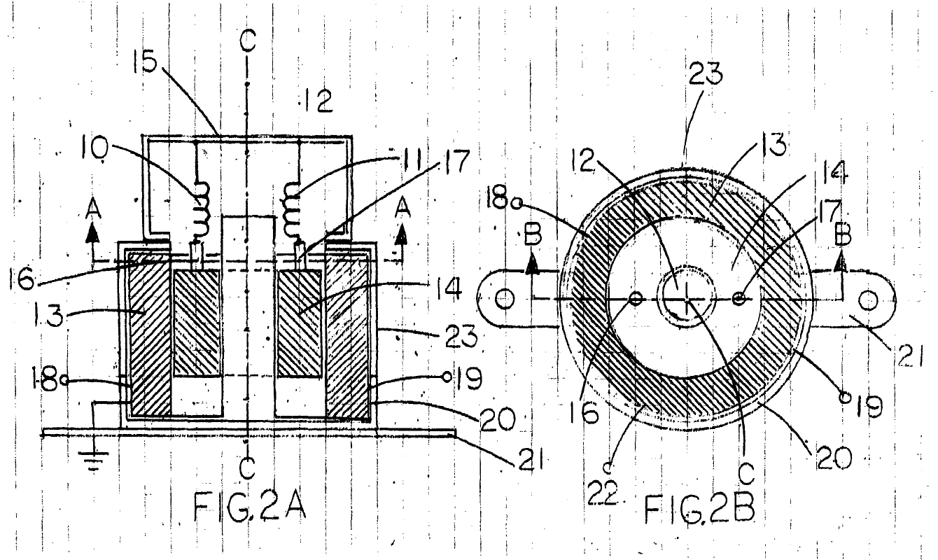

With reference to FIGS. 2A, and 2B, a magnetic sensor/generator 23 comprises a toroidally shaped coil 13 concentrically surrounding a toroidal permanent magnet 14 guided in its vertical motion by the shaft 12 in its center and suspended by the springs 10 and 11. The springs 10 and 11 are fastened on one end to the structure 15, which is a part of the enclosure 20 and on the other end to bosses 16 and 17 protruding from the magnet 14. The shaft 12 that guides the magnet 14 in its vertical motion is fabricated of a non-magnetic material, such as aluminum or brass, or of a suitable rigid polymer. The enclosure 20 is also fabricated of a non-magnetic metal or suitable polymer. The flange 21 is used to fasten the sensor/generator 23 to the motor.

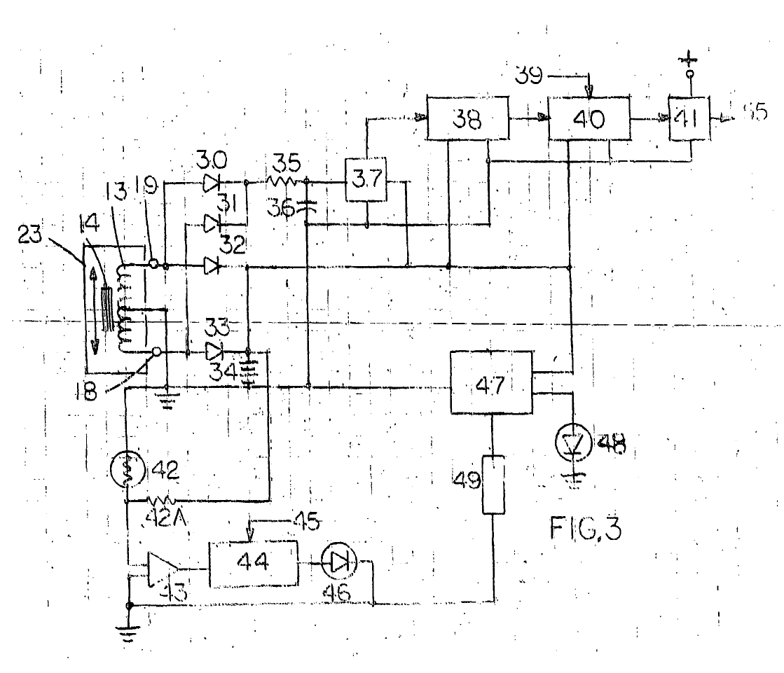

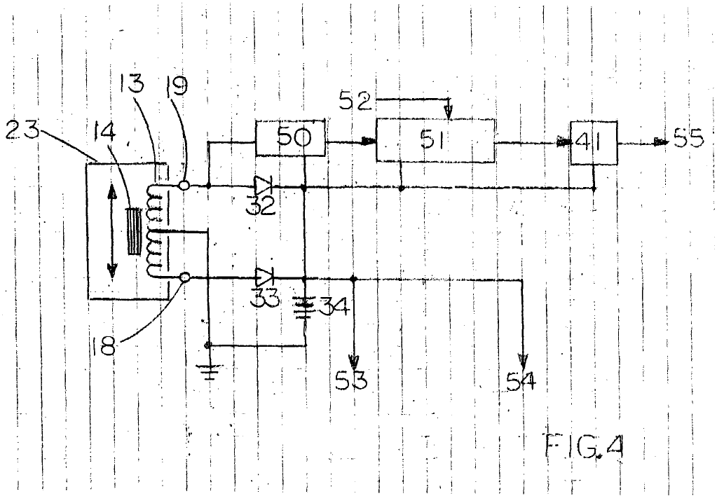

When the motor vibrates during its operation the sensor/generator 23 fastened to the motor also vibrates. Due to inertia, the magnet 14 moves vertically up and down. Because the magnet 14 and the springs 10 and 11 are selected to form a structure with a resonant frequency equal to that of the fundamental frequency of motor's vibration, the amplitude of the motor's movement is increased. The movement of the magnet 14 with respect to the coil 13 generates an alternating current at coil's terminals 18 and 19. The magnitude of the current is proportional to the range of the magnet's 14 motion, the frequency of the motion, the magnet's 14 strength, and the number of turns in the coil 13. The physical parameters to achieve resonance can be calculated taking into account the type of an electric motor to which this system is applied, such motors generally operate at 1800 or 3600 RPM. The electric current is used to sense when the motor is operating and the number of shaft revolutions, as well as to generate power for recharging a battery 34 of FIGS. 3 and 4.

Referring now to FIG. 3, which is a schematic block diagram of one version of the lubrication control system and a power supply. The coil 13 of the sensor/generator module 23 is center-tapped to common ground and the output terminals 18 and 19 of the coil 13 are connected to the control system. The AC output of the coil 13 provides, in conjunction with the diodes 32 and 33, a full-wave rectifier that supplies the current, which trickle charges the battery 34. The secondary battery 34 powers the entire control system. and the lubricant dispenser 54.

Diodes 30 and 31 generate direct current when the motor operates. The resistor 35 and the capacitor 36 smooth the direct current. The resulting signal is fed into a first switch 37 that can be either mechanical or a solid-state relay. The switch 37 controls the pulse generator 38 that feeds only when the motor operates the pulses generated into the presettable counter 40. The preset value is entered via the input 39 into the counter 40. The counter 40 accumulates the pulses until the preset quantity is reached. At that point, the preset counter 40 activates the second switch 41, which can be a mechanical or a solid-state relay and resets itself. The switch 41 actuates the lubricant dispensing module 54 (FIGS. 1A. and 1B). This control system ensures that the lubricant is injected in time intervals that are a function of the cumulative time of the operation of the motor.

FIG. 3 also shows temperature indicator circuit comprising thermistor 42, resistor 42A, amplifier 43, an adjustable Schmidt trigger 44, and the indicator LED 46. The temperature of the motor bearing to which the thermistor 42 is attached controls the resistance of this thermistor. The resulting signal is amplified and input into the Schmidt trigger 44 the threshold of which is adjustable via the input 45. When the input signal to the Schmidt trigger 44 reaches the trigger level, the LED 46 is activated, indicating overheating. The LED preferably is made to flash rather than be steadily lit; flashing attracts attention. It is understood that trigger circuits other than Schmidt triggers could be used to provide the same function. It is also understood that the LED 46 could be replaced by a lamp, an audio signal generator or by a means to generate alarm at a remote location.

Another subsystem is designed to monitor in real time the volume of the lubricant in the supply container. The subsystem comprises the capacitive proximity sensor 49, the control electronics 47, and a signaling LED 48. A signal is generated by the sensor 49 when the supply container is almost empty, requiring refill, which happens when the piston 70 (FIG. 1B) is close to the bottom of the lubricant dispenser 54. The capacitive proximity sensor 49 is isolated from the body of the lubricant dispenser 54 by the insulating pedestal 75.

Alternatively, the volume of the lubricant can be inferred by accumulating in formation on the cumulative displacement of the piston 70. from its initial position when the variable internal volume 76 with the piston 70 is completely retracted meaning is filled with the lubricant. By counting the pulses driving the motor 74 is a stepper motor or if the motor 74 is a DC motor, by accumulating the time intervals when the motor is running. Either of these functions can be incorporated in the module 41.

FIG. 4 is a block diagram of an alternate system for controlling injection of lubricants in the motor bearings. It also incorporates the sensor/generator 23 and the power supply system comprising the diodes 32 and 33 and a battery 34. Module 50 receives its signals from the terminal 19 of the coil 13 and shapes the input signals into pulses. These pulses are fed into the preset counter 51 where they are accumulated. Each pulse represents one rotation of the motor shaft. The preset number is entered via the input 52. When the number of pulses reaches the preset value, the counter 51 signals the switch 41, which consequently actuates the lubricant dispensing module. This control system also ensures that the lubricant is injected in time intervals that are a function of the cumulative time of the operation of the motor. Output 53 leads to the temperature monitoring sub-system and output 54 leads to the sub-system that monitors the level of the lubricant in the container.

I claim:

1. An automatic lubrication control system for a cyclically moving mechanism having bearings comprising:
an electromagnetic sensor/generator actuated by vibrations of said mechanism and providing an output, and control means for effective injection of a lubricant from a lubricant dispensing module into the bearings of said cyclically moving mechanism in response to said output.

2. The system per claim 1 further comprising a power supply responsive to the output of said sensor generator for providing operating electric current for said control means in response to said output.

3. A system in accordance with claim 2 in which said sensor/generator comprises a toroidally-shaped electric coil; a toroidally-shaped permanent magnet within said coil, said magnet being movable along the major vertical axis of said automatic lubrication system

4. A system in accordance with claim 3 in which said magnet is suspended by means of springs within the central opening of said coil and is a cylindrical shaft situated within the central opening of said magnet for constraining the motion thereof.

5. A system in accordance with claim 3 wherein said sensor/generator comprises a structure including a magnet and a coil, said structure being mounted on said mechanism, where said structure being resonant at the fundamental frequency of said vibrations of said mechanism

6. A system in accordance with claim 1 in which said mechanism is an electric motor.

7. A system in accordance with claim 4 in which said shaft is made of non-magnetic material.

8. A system in accordance with claim 1 in which said power supply comprises rectifier diodes and a secondary battery receiving its charging current from said coil via said rectifier diodes, said battery supplying said operating current.

9. A system in accordance with claim 1 in which electrical signals from said coil are rectified, filtered and input into a first switching means said first switching means turning a pulse generator on or off responsive to the operation of said mechanism.

10. A system in accordance with claim 9 in which said pulse generator feeds pulses into a presettable digital counter, said counter accumulating said pulses until the preset number of pulses is reached, resetting itself to a zero count and generating an output signal, said output signal actuating a second switching means, said second switching means initiating the injection of lubricant into the bushings of said motor.

11. An automatic lubrication system in accordance with claim 1 that includes a temperature monitoring sub-system and a sub-system for monitoring the level of said lubricant.

12. An automatic lubrication system in accordance with claim 1 further comprising that comprises
a cylindrically shaped container for said lubricant,
a piston within said container, said piston being movable to eject said lubricant from said container into said bearings in response r to the output of said magnetic sensor/generator.

12. An automatic lubrication system in accordance with claim 1, which includes means for signaling excessive temperatures in said motor.

13. An automatic lubrication system in accordance with claim 1, which includes means for signaling low levels of said lubricant.

14. A control system in accordance with claim 5 in which electrical signals generated in said coil are input into a pulse shaping means, said pulse shaping means feeding pulses into a digital presettable counter responsive to said pulses, being resettable to zero and generating an output signal to a second switching means when the number of accumulated pulses in said counter reaches the preset number.

15. A control system in accordance with claim 14 further comprising in said control means said second switching means responsive to said signal from the presettable counter actuates the injection of the lubricant into said motor bearings

16. A control system in accordance with claim 11 in which said lubricant dispensing module contains a container having a sensor that monitors the volume of said

17. A control system in accordance with claim 16 in which said sensor a capacitive proximity transducer.

18. A control system in accordance with claim 11 in which said control means is operative for measuring the level of said lubricant in response to the displacement of said piston.
